(19) United States
(12) Patent Application Publication
(10) Pub. No.: US 2012/0247834 A1
(43) Pub. Date: Oct. 4, 2012

(54) CUTTING ELEMENT HAVING MODIFIED SURFACE

(75) Inventors: David Wayne Buxbaum, Columbus, OH (US); Neil Krishman, Columbus, OH (US)

(73) Assignee: DIAMOND INNOVATIONS, INC., Worthington, OH (US)

(21) Appl. No.: 13/432,185

(22) Filed: Mar. 28, 2012

Related U.S. Application Data
(60) Provisional application No. 61/468,414, filed on Mar. 28, 2011.

(51) Int. Cl. E21B 7/00; B21K 5/02; E21B 10/36; B23B 51/00

(52) U.S. Cl. 175/57; 408/199; 76/115; 175/428

(57) ABSTRACT

A cutting element including a cutting face and a longitudinal axis passing through the cutting face. The cutting element includes at least a first portion of the cutting face that is angled at an angle of about 81 to about 89 degrees relative to the longitudinal axis of the cutting element. The cutting element can further include a substrate, a superabrasive an interface between the substrate and superabrasive layer. Further, the cutting face is provided with a surface roughness of 40 microinches or less.

### TECHNICAL FIELD AND INDUSTRIAL APPLICABILITY

The present disclosure relates to a cutting element, for example, cutters utilized in drilling subterranean formations. More specifically, the present disclosure relates to cutting elements intended to be installed on a drill bit or other tool used for earth or rock boring, such as may occur in the drilling or enlarging of an oil, gas, geothermal or other subterranean borehole, and to bits and tools so equipped. The cutting elements include at least a first portion that has an angle of about 81 degrees to about 89 degrees relative to the longitudinal axis. The disclosure also relates to a method of making the cutting element, and a method of using the cutting element.

### BACKGROUND

In the discussion of the background that follows, reference is made to certain structures and/or methods. However, the following references should not be construed as an admission that these structures and/or methods constitute prior art. Applicant expressly reserves the right to demonstrate that such structures and/or methods do not qualify as prior art.

One type of drill bit generally used to drill through subterranean formations is a drag bit or fixed-cutter bit. Such drill bits utilize numerous cutters or cutting elements that are brazed or pressed into the drill bit to cut, plow, and shear the subterranean formations.

Currently available cutters include a planar cutting face that is transverse to the longitudinal axis of the cutting element and forms the top surface of the cutting element. FIG. 20A is an example of cutting with a traditional drag bit 107 including at least one traditional cutting element 109. The cutting element 109 is brazed or pressed into the drag bit 107 for subterranean formation drilling. The cutting element 109 is mounted into the drag bit 107 at a certain angle which is called the back-rake angle β. The back-rake angle β is the angle between the drag bit axis 110 and the front surface 112 of the superabrasive material. The back-rake angle in many drag bits is between about 15° and about 25°, but can be as high as 30° or even 45°.

As illustrated in FIG. 20A, the cutting element will plow and shear the subterranean formation 108 to form a hole during the cutting operation. As illustrated in FIG. 20B, after a certain period of drilling, the cutting element will generally have a wear pattern or wear surface 114 with a wear angle γ that is approximately complementary to the back-rake angle β. The wear angle γ is the angle between the cutting element longitudinal axis 116 and the wear surface 114.

In addition to wearing at an angle as represented in FIG. 20B, the cutter loading may otherwise cause chipping or spalling of the diamond layer at an unchamfered cutting edge shortly after a cutter is put into service and before the cutter naturally abrades to a flat surface, or “wear flat” at the cutting edge. Chipping of the cutting face during wear leads to a degradation of the cutting edge, and thus leads to inefficient plowing and shearing of the subterranean formation during drilling operations.

It was determined that a bevel or chamfer protected the cutting edge from load-induced stress concentrations by providing a small load-bearing area which lowers unit stress during the initial stages of drilling. However, even cutters with a chamfer, such as the cutter represented in FIG. 21, still typically experience chipping of the cutting face during wear.

Other cutters have included non-planar cutting faces in the form of a continuous curved surface. Still further cutters having included cutting faces including more than one chamfer with different angles in relation to the longitudinal axis of the cutting element. While these cutters may have achieved some enhancement of cutter durability, there remains a great deal of room for improvement.

### SUMMARY

The cutting element of the present disclosure has longer wear life by reducing the amount of chipping of the cutting face of the cutting element during use. The disclosed cutting element improves wear life and reduces chipping at least by incorporating a portion of the cutting face other than a traditional with an angled surface.

A first aspect of the invention includes a cutting element including a cutting face and a longitudinal axis passing through the cutting face. The cutting face includes at least a first portion having an angle of about 81 to about 89 degrees relative to the longitudinal axis of the cutting element.

A second aspect of the invention includes a cutting element including a cutting face. The cutting face includes at least a first portion having an angle of about 81 to about 89 degrees relative to the longitudinal axis of the cutting element. Further, the cutting face has a surface roughness of about 40 microinches or less.

A third aspect of the invention includes a cutting element including a diamond table, a substrate, and a non-planar interface between the diamond table and the substrate. The diamond table includes a cutting face. The cutting face includes at least a first portion having an angle of about 81 to about 89 degrees relative to the longitudinal axis of the cutting element. Said first portion of the cutting face has a surface roughness of about 5 to about 7 microinches. Further, said first portion of the cutting face has an extent, (A) as shown in FIG. 29, in the longitudinal direction of about 125 microns to about 800 microns.

A fourth aspect of the invention includes a cutting element including a cutting face and a longitudinal axis passing through the cutting face. At least a first portion of the cutting face is at an angle of about 81 to about 89 degrees relative to the longitudinal axis of the cutting element. Further, the cutting element does not chip when subjected to a 16 mm dynamic impact test for at least about 20 minutes.

A fifth aspect of the invention includes a method of making a cutting element including forming a cutting element having a cutting face and modifying the cutting face to form at least a first portion of the cutting face having an angle of about 81 to about 89 degrees relative to the longitudinal axis of the cutting element. The modification process provides a surface roughness of about 40 microinches or less on the first portion of the cutting face.

A sixth aspect of the invention includes a cutting element for drilling subterranean formations including a cutting face, a cutting edge at the periphery of the cutting face, and a longitudinal axis passing through the cutting face. The cutting face includes at least a first portion at an angle of about 81 to about 89 degrees relative to the longitudinal axis of the cutting element. The cutting element plows and shears the subterranean formation such that at least a portion of the first portion of the cutting face is engaged with the subterranean formation.

A seventh aspect of the invention includes a cutting element including a cutting face and a longitudinal axis passing through the cutting face. At least a first portion of the cutting face is at an angle of about 81 to about 89 degrees relative to the longitudinal axis of the cutting element. Further, the cutting element has significantly reduced chipping when subjected to an abrasion test on a vertical turret lathe (VTL) for 20,000 meters.

It is to be understood that both the foregoing general description and the following detailed description are exemplary and explanatory and are intended to provide further explanation of the invention as claimed.

### BRIEF DESCRIPTION OF THE DRAWINGS

The following detailed description can be read in connection with the accompanying drawings in which like numerals designate like elements and in which:

FIG. 1 shows a perspective exploded view of a cutting element according to a first embodiment of the invention.

FIG. 2 shows a top view of the cutting element of FIG. 1.

FIG. 3 shows a partial cross sectional view of the cutting element of FIG. 1.

FIG. 4 shows a view of the cutting element of FIG. 1 orthogonal to the longitudinal axis

FIG. 5 shows an exploded cross sectional view of the cutting element of FIG. 1 cut along line V-V.

FIG. 6 shows an exploded cross sectional view of the cutting element of FIG. 1 cut along line VI-VI.

FIG. 7 shows a view of a cutting element orthogonal to the longitudinal axis according to a second embodiment of the invention.

FIG. 8 shows a partial view of a cutting element orthogonal to the longitudinal axis according to a third embodiment of the invention.

FIG. 9 shows a top view of a cutting element according to a fourth embodiment of the invention.

FIG. 10 shows a view of the cutting element of FIG. 9 parallel to the line X-X.

FIG. 11 shows a view of the cutting element of FIG. 10 parallel to the line XI-XI.

FIG. 12 shows a top view of a cutting element according to a fifth embodiment of the invention.

FIG. 13 shows a view of the cutting element of FIG. 12 parallel to the line XIII-XIII.

FIG. 14A shows a top view of the substrate of a cutting element according to a sixth embodiment of the invention prior to applying a top layer that contains a cutting face.

FIG. 14B shows a cross sectional view of the substrate of FIG. 14A.

FIG. 15A shows a top view of the substrate of a cutting element according to a seventh embodiment of the invention prior to applying a top layer that contains a cutting face.

FIG. 15B shows a cross sectional view of the substrate of FIG. 15A.

FIG. 16A shows a top view of the substrate of a cutting element according to a eighth embodiment of the invention prior to applying a top layer that contains a cutting face.

FIG. 16B shows a cross sectional view of the substrate of FIG. 16A.

FIG. 17 shows a cutting element according to a ninth embodiment of the invention during a cutting operation.

FIG. 18 is a graph showing how different cutting elements perform in a Dynamic Impact Test.

FIG. 19 is a graph showing how different cutting elements perform in a Vertical Turret Lathe test.

FIG. 20A shows a drag bit with a traditional cutting element during a cutting operation.

FIG. 20B shows a drag bit with a traditional cutting element after a certain amount of wear has occurred.

FIG. 21 is a photograph of a known cutting element after being subjected to a Vertical Turret Lathe Test.

FIG. 22 is a photograph of a cutting element according to a tenth embodiment of the invention after being subjected to a Vertical Turret Lathe Test.

FIG. 23 is a photograph of a known cutting element after being subjected to a Dynamic Impact Test.

FIG. 24 is a photograph of a cutting element according to an eleventh embodiment of the invention after being subject to a Dynamic Impact Test.

FIG. 25A shows a top view of a cutting element according to a twelfth embodiment of the invention.

FIG. 25B shows a view of the cutting element of FIG. 25A orthogonal to the longitudinal axis.

FIG. 26A shows a top view of a cutting element according to a thirteenth embodiment of the invention.

FIG. 26B shows a view of the cutting element of FIG. 26A orthogonal to the longitudinal axis.

FIG. 27 shows a top view of a cutting element according to a fourteenth embodiment of the invention.

FIG. 28 shows a top view of a cutting element according to a fifteenth embodiment of the invention.

FIG. 29 shows a table and drawing showing various geometric features of the invention.

### DETAILED DESCRIPTION

Disclosed is an improved cutting element. Such cutting elements can be used as, for example, but not limited to, superabrasive cutters used in drag bits. The improved cutting element includes, among other improvements, reduction in chipping, improved wear, and longer tool life. The improvements are at least partially attributed to the addition of a first portion of the cutting face of the cutting element having an angle of about 81 degrees to about 89 degrees relative to the longitudinal axis of the cutting element.

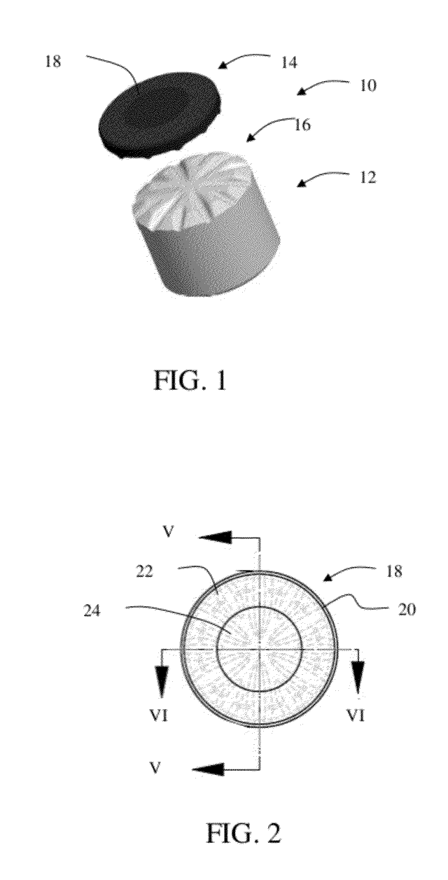

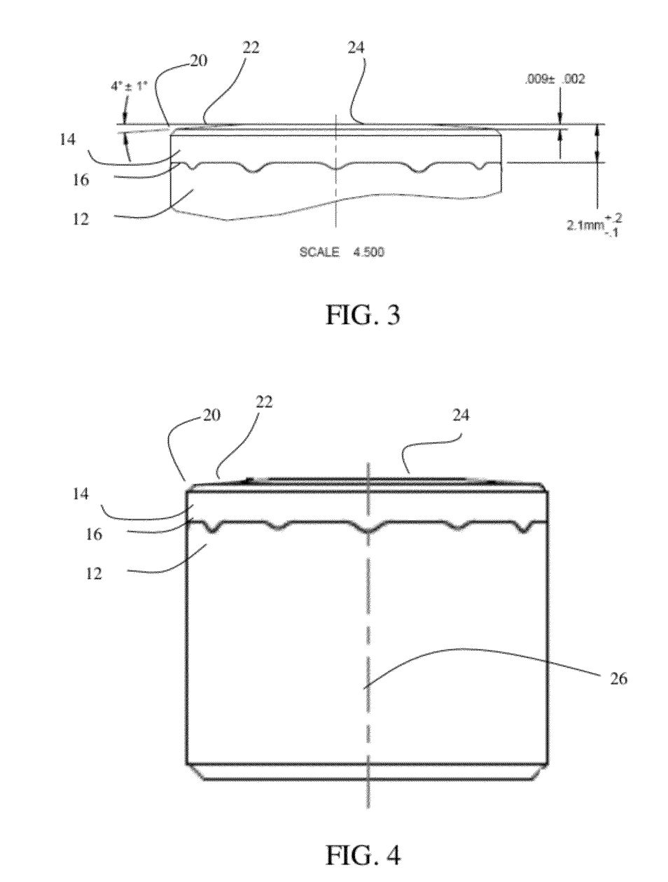

A first embodiment of a cutter containing the improved cutting face is illustrated in FIGS. 1-6. The cutting element 10 includes a substrate 12, a superabrasive layer 14, and an interface 16 between the substrate 12 and superabrasive layer 14. The superabrasive layer 14 includes a cutting face 18 forming the top surface of the cutting element 10. In an embodiment, the cutting face may include a chamfer 20, a first portion 22, and a second portion 24. As exemplified in FIG. 3, the first embodiment has a first portion of the cutting face with an angle of about 86 degrees relative to the longitudinal axis 26 of the cutting element. In this particular embodiment, the thickness of the superabrasive layer is about 2.1 mm and the axial dimension of the first portion of the cutting face is about 0.009 mm.

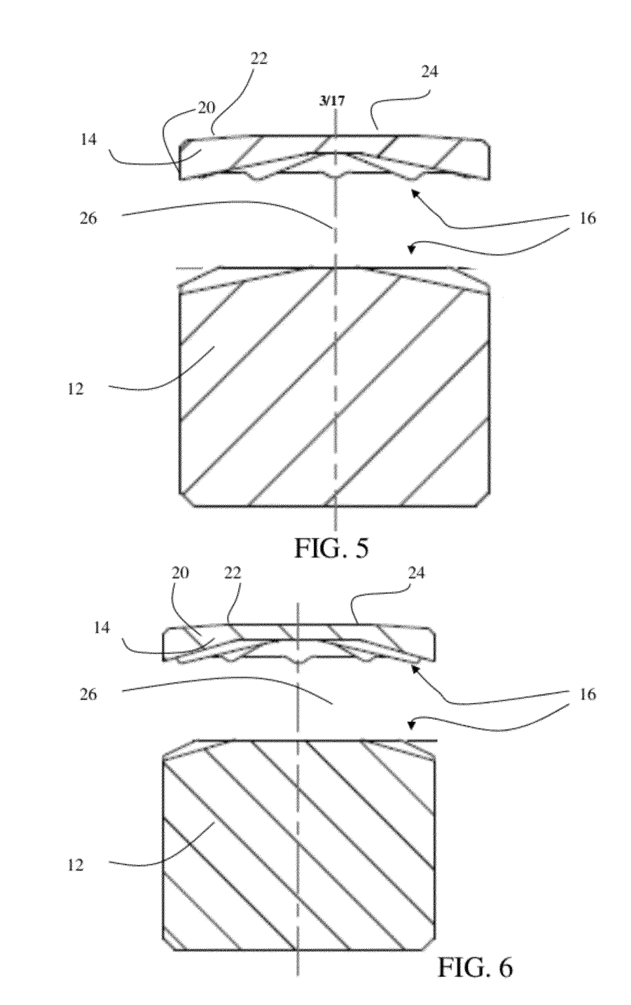

In embodiments, the interface may have a star interface. As seen in FIG. 1, the top surface of the substrate contains a star pattern with alternating grooves of different length and depth radiating from the longitudinal axis. A corresponding surface is present on the bottom surface of the superabrasive layer so as to form an interconnecting interface. The interaction at the interface at the two different groove patterns forming the star pattern are seen in the exploded cross sectional views of FIGS. 5 and 6.

In addition to the embodiment of FIGS. 1-6 having only a first and second portions of the cutting face, as well as a chamfer, the cutting face can be formed having multiple portions, each having a different angle relative to the longitudinal axis of the cutting element. Further, the cutting element can be formed with or without a chamfer.

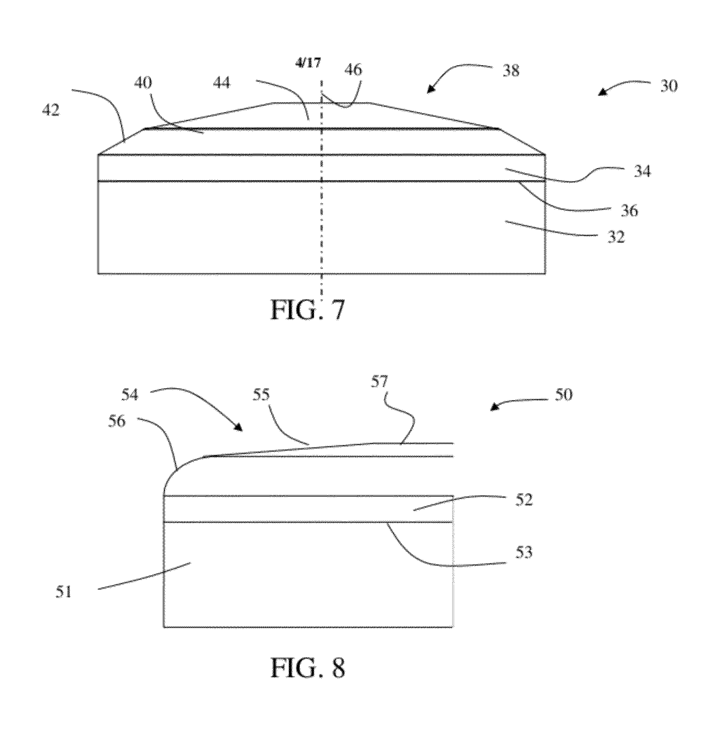

FIG. 7 illustrates a second embodiment. The cutting element 30 includes a substrate 32, a superabrasive layer 34, and an interface 36. The superabrasive layer 34 includes a cutting face 38 having a first portion 40, second portion 42, and a third portion 44. At least the first portion has an angle relative to the longitudinal axis 46 of about 81 degrees to about 89 degrees.

FIG. 8 illustrates a third embodiment. The cutting element 50 includes a substrate 51, a superabrasive layer 52, and an interface 53. The superabrasive layer 52 includes a cutting face 54 having a first portion 55, a curved portion 56, and a second portion 57.

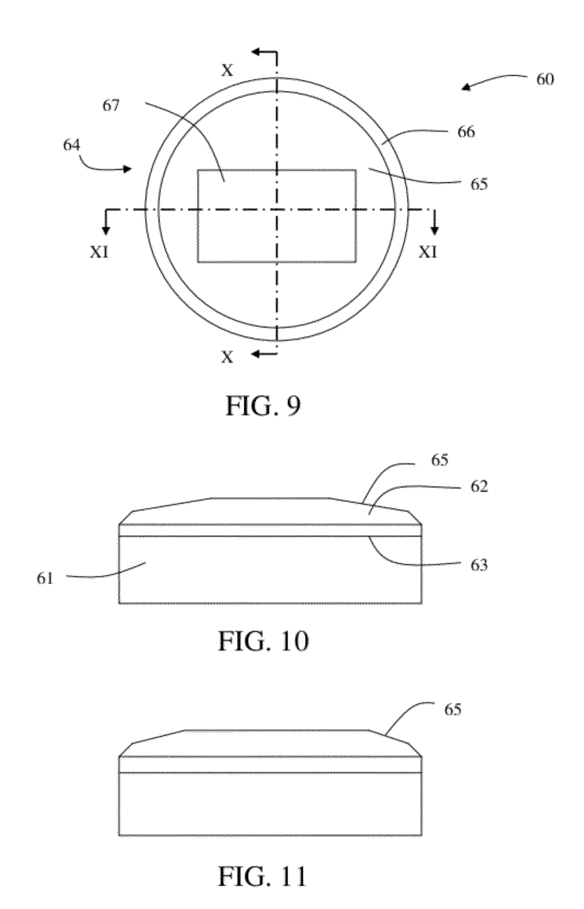

FIGS. 9-11 illustrate a fourth embodiment. The fourth embodiment is an example of cutting element where the first portion of a cutting face does not form a uniform ring around the longitudinal axis. The cutting element 60 includes a substrate 61, a superabrasive layer 62, and an interface 63. The superabrasive layer 62 includes a cutting face 64 having a first portion 65, a chamfer 66, and a second portion 67. As illustrated in FIG. 9, the radius of the second portion 67 is different depending on the direction.

This is caused by modifying the superabrasive layer such that a rectangular shape of superabrasive layer that has not been modified is left in the center of the cutting face. As illustrated in FIGS. 10 and 11, the difference in the radius of the second portion causes the first portion 65 to have a different angle relative to the longitudinal axis of the cutting element and a different length depending on the direction of the cutting element. This selective angle and length, allows the cutting element 60 to be indexable, such that the cutting element can be used in four different positions within the drill bit. Further, the rectangular shaped second portion makes it easy for a user to align the cutting element for each of the four positions.

Examples of modification methods include, but are not limited to, lapping, polishing, abrasive grinding, discharge machining methods, discharge grinding methods, tribochemical machining, laser cutting, or any other process known to provide a surface finish with for example a surface roughness of 40 microinches or less.

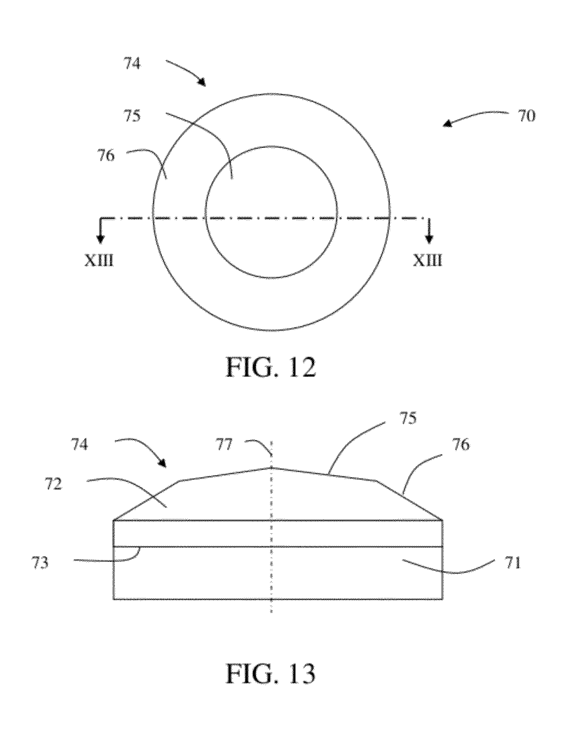

FIGS. 12-13 illustrate a fifth embodiment. The cutting element 70 includes a substrate 71, a superabrasive layer 72, and an interface 73. The superabrasive layer 72 includes a cutting face 74. The fifth embodiment is an example of a cutting element according to the invention in which the first portion having an angle relative to the longitudinal axis of about 81 degrees to about 89 degrees is continuous up to the longitudinal axis of the cutting element. In particular, the cutting face 74 includes a first portion 75 and a second portion 76. As illustrated in FIG. 13, the first portion 75 of the cutting face comes to its highest point at the longitudinal axis 77 of the cutting element.

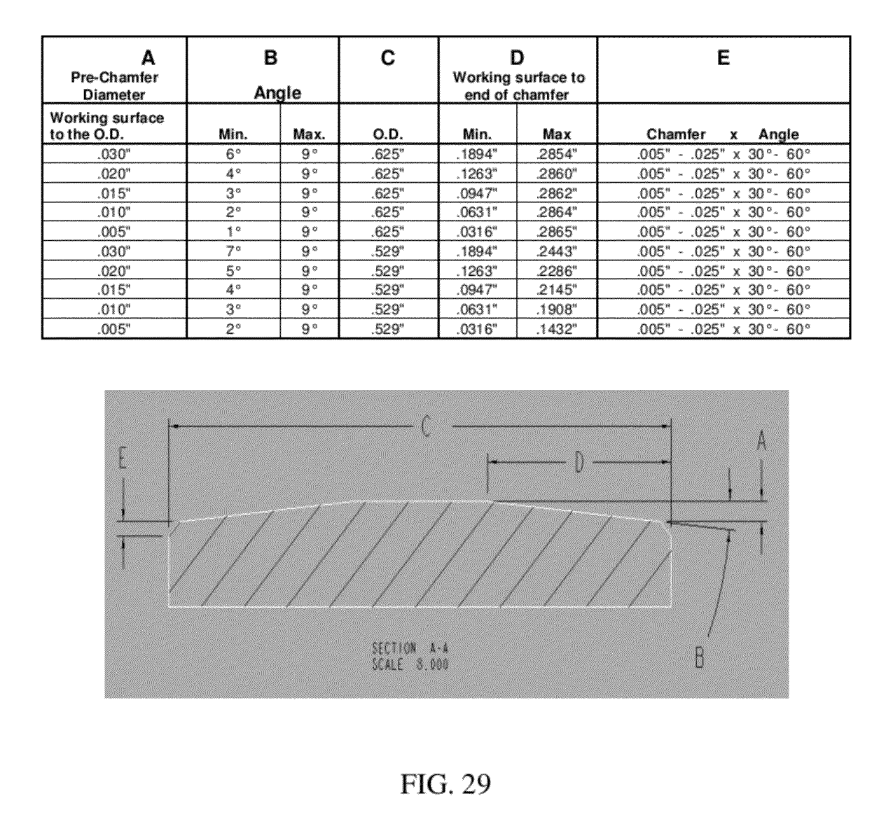

As seen in at least the embodiments described above, the first portion of the cutting element can be located at different locations along the cutting face relative to the longitudinal axis of the cutting element. For example, where the first portion does not contact the longitudinal axis, the first portion of the cutting face forms a ring around the longitudinal axis of the cutting element with the radial dimension, (D) as shown in FIG. 29, of the ring being about 0.5 mm to about 8 mm, such as for a 16 mm cutter. In more particular embodiments, the first portion of the cutting face forms a ring around the longitudinal axis of the cutting element with the radial dimension of the ring being about 2 mm to about 4 mm.

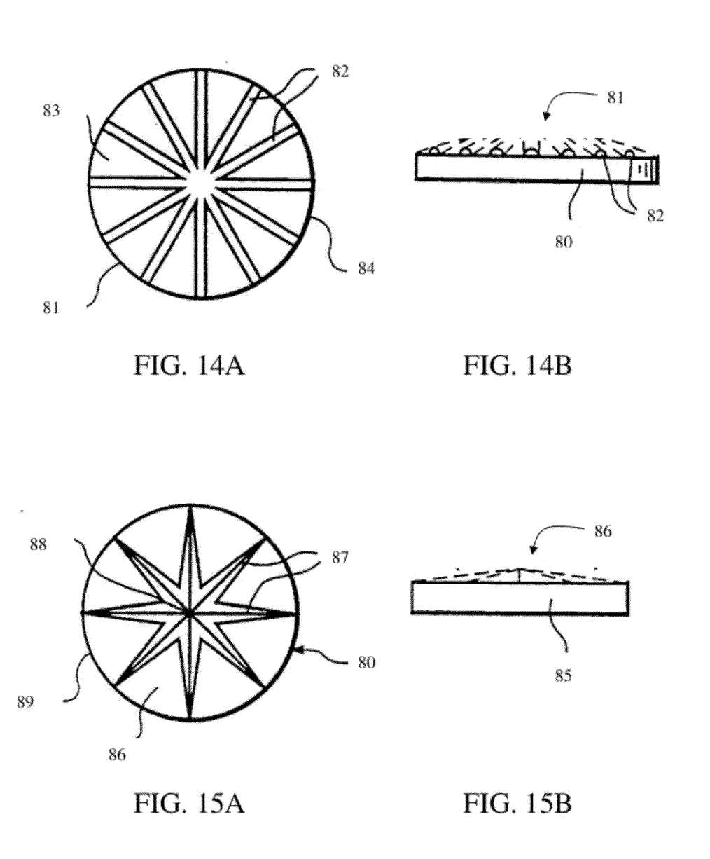

FIGS. 14A-16B illustrate specific embodiments of cutting elements having different interfaces between the substrate and superabrasive layers. Any of the interfaces described previously or any of the interfaces illustrated in FIGS. 14A-16B, as well as any other known interfaces can be used in any of the previously described embodiments.

FIGS. 14A and 14B illustrate a cutting element substrate 80 having a convex top surface 81, which has lands 82 of arcuate cross section extending from a center portion 83 to the periphery 84 of the substrate 80. The superabrasive layer is itself arcuate, or convex, in configuration, following the contour of the convex top surface 81 of the cutting element substrate 80.

FIGS. 15A and 15B illustrate a cutting element substrate 85 having a top surface 86, which has lands 87 of triangular cross section that decrease in height from a center portion 88 to the periphery 89 of the cutting element substrate 85.

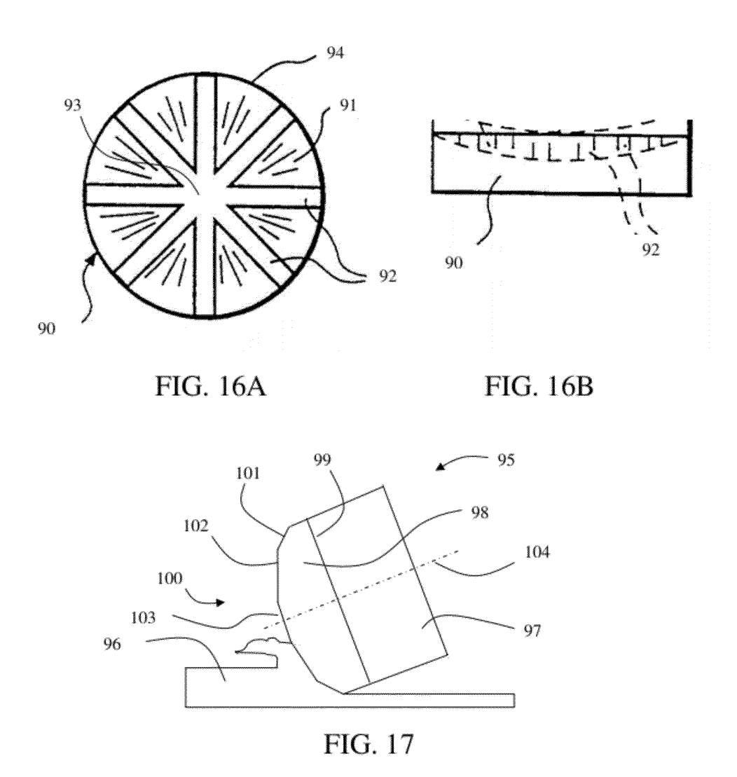

FIGS. 16A and 16B illustrate a cutting element substrate 90 having a concave top surface 91, which has lands 92 extending from the periphery 94 to the center 93 of the cutting element substrate 90 with a constant level upper surface and thereby a steadily increasing height as the center 93 of cutting element substrate 90 is approached.

FIG. 17 illustrates a cutting element 95 in accordance with an embodiment of the invention being used to drill a subterranean formation 96. The cutting element 95 includes a substrate 97, a superabrasive layer 98, and an interface 99 between the substrate and superabrasive layer. The superabrasive layer 98 includes a cutting face 100, which includes a chamfer 101, a first portion 102, and a second portion 103. The first portion is at an angle of about 81 degrees to about 89 degrees to the longitudinal axis 104 of the cutting element 95. During the drilling process, the cutting element 95 cuts a depth into the subterranean formation 96 such that the first portion 102 contacts the subterranean formation 96. For example, the distance to which the cutting element cuts into a subterranean formation is at least about 100 meters.

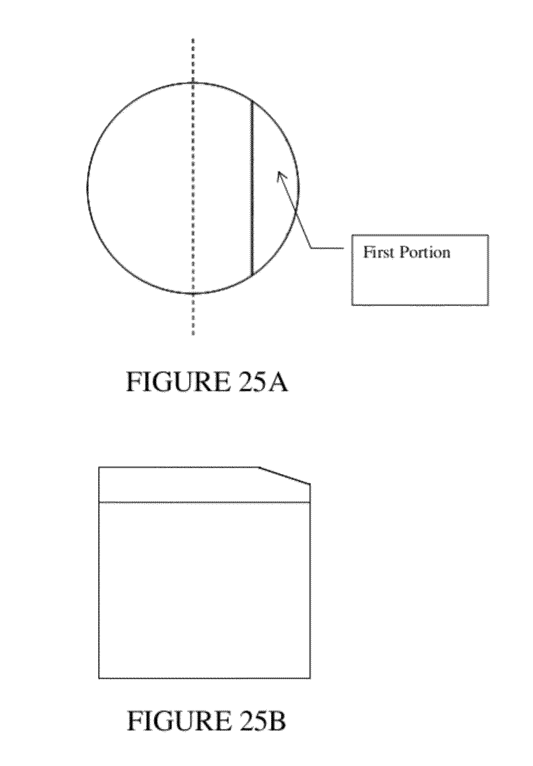

FIGS. 25A and 25B illustrate an embodied cutting element in which the first portion of a cutting face comprises a circumferential portion of the cutting surface. One or more such first portions may be present on the cutter.

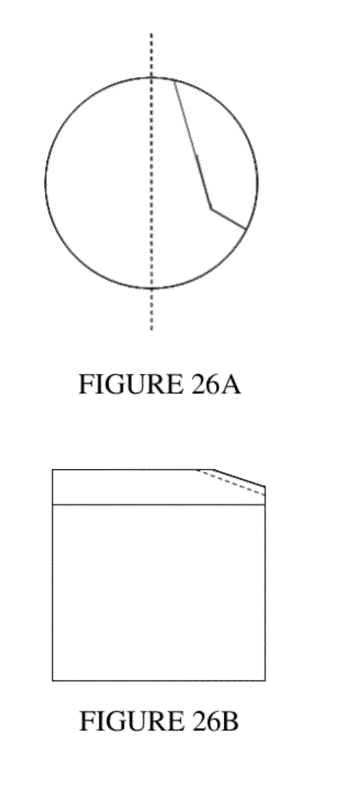

FIGS. 26A and 26B illustrate an embodied cutting element in which the first portion of a cutting face comprises a circumferential portion of the cutting surface and oriented at multiple angles to the longitudinal axis to push cut formation debris in a preferred direction.

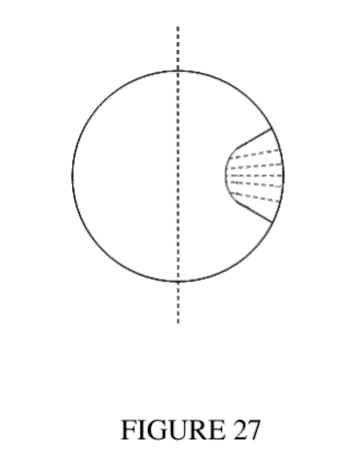

FIG. 27 shows a first portion having a radially oriented non planar surface, as the groove shown, instead of the previous embodied planar portion. In this embodiment the non planar surface may be concave, convex, or other non planar geometry.

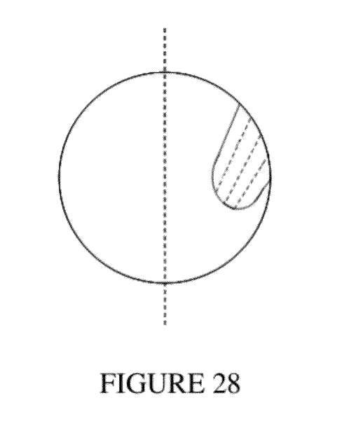

FIG. 28 shows a first portion having a non planar surface oriented at multiple angles with respect to the longitudinal axis.

FIG. 29 shows a table and drawing showing various geometric features of embodiments.

Features from each of the above embodiments may be included in different combinations to form additional embodiments. In further embodiments, the cutting face of the cutting elements may include any number of portions, each having different angles relative to the longitudinal axis of the cutting element. In yet further embodiments, the cutting face of the cutting elements may include more than one chamfer in addition to the multiple portions having different angles. In still other embodiments, the interface below the first portion may be modified to adjust the superabrasive layer thickness in the first portion.

As shown, each of the embodiments discussed above include a cutting face having a “convex” surface, where “convex” is referring to a surface that is either a convex curved surface or a surface containing angled planar portions where if points where the portions meet were rounded a convex shape would be formed. In other embodiments, the cutting face may have a “concave” surface or “saddle” surface. “Concave” surface refers to not only a cutting face in which the face has a concave curved shape, but also a surface in which at least some of the angled planar portions would form a concave surface if the connection points of the planar portions were rounded. Similarly, “saddle” surface refers to a cutting face in which a curved surface or surface with angled planar portions curves gently between two slopes and resembles the shape of a saddle.

In certain embodiments, the substrate is formed of a carbide. In more certain embodiments, the carbide is a cemented carbide. In yet more certain embodiments, the cemented carbide is tungsten carbide. In still yet more certain embodiments, the cemented carbide includes chromium.

In particular embodiments, the superabrasive layer is formed of diamond. In more particular embodiments, the diamond is a polycrystalline diamond. In yet more certain embodiments, the polycrystalline diamond is leached.

In certain embodiments, the superabrasive layer may further comprise a coating on the cutting surface. The coating may comprise CVD diamond, Diamond Like Carbon (DLC), nanocrystalline diamond or other superhard materials as known. The coating may comprise materials that modify the frictional properties of the cutting surface and/or the coating may comprise materials that modify the chemical properties of the cutting surface and improve life in corrosive subterranean formations. The coatings may be applied only to a portion of the cutting surface.

In certain embodiments, the chamfer described above may have an angle of about 20 to about 70 degrees relative to the longitudinal axis of the cutting element. In more certain embodiments, the chamfer may have an angle of about 30 degrees to about 60 degrees. In yet more certain embodiments, the chamfer may have an angle of about 40 degrees to about 50 degrees.

The cutting elements in accordance with the embodiments above may be made by forming a substrate and superabrasive layer, and then sintering the substrate and superabrasive layer together to form a single cutting element. The at least first portion of the cutting face of the superabrasive layer is formed by modifying the cutting surface by removing a portion of the superabrasive layer. In particular embodiments, after formation of the cutting element, the top surface of the superabrasive layer is subjected to modifying to form the angled portions of the cutting face.

In addition to forming a particular angle, it is desired to form a cutting face having a surface finish with controlled surface roughness. Alternatively, the superabrasive may be removed by other known methods including, but not limited to, lapping, polishing, abrasive grinding, discharge machining methods, discharge grinding methods, tribochemical machining, laser cutting, or any other grinding process known to provide a surface finish with for example a surface roughness of 40 microinches or less.

In certain embodiments, the surface roughness of at least the first portion of the cutting element is about 40 microinches or less, preferably about 30 microinches or less, more preferably about 20 microinches or less, or yet more preferably about 10 microinches or less. In more certain embodiments, the surface roughness of at least the first portion of the cutting element is about 2 microinches or greater or preferably about 5 microinches or greater. In a particular embodiment, the surface roughness of the cutting face is about 5 to about 7 microinches.

The surface roughness (Ra) is measured with an interferometer such as a WYKO NT1100 white light interferometer manufactured by Veeco Instruments (Plainview, N.Y.). The measurements are taken at four specific locations, i.e. the lapped surface, the modified surface, the chamfer and the OD of the diamond table. All measurements are done at a combined total magnification of 5×, except for the chamfer region where a magnification of 20× is used due to the small chamfer width. The scan area for 5× scans is 1.2 mm×0.9 mm, while that of the 20× scans on the chamfer is 0.30 mm×0.23 mm and all surface scans were corrected to remove tilt and cylindricity.

Stylus profilometry is not a good measurement of surface roughness for the particular cutting elements disclosed as the stylus is a diamond tip which will wear when measuring a diamond surface such as that on the surface of a cutting element. As such, the results may be skewed making the surface readings appear smoother than they actually are.

The improvement in reduced chipping and improved cutter life can be shown by comparing the cutting elements in accordance with the above embodiments with more traditional cutters having a chamfer, but no “first portion” of the cutting face, using both the Dynamic Impact Test and the Vertical Turret Lathe Test.

The Dynamic Impact Test was performed using horizontal spindle milling machine while subjecting cutting elements with a 0.007″ ground chamfer to repeated strikes against a 40 pound spring loaded fixture with a urethane rebound damper holding a high speed tool steel bar clamped to the machine table. A cutting element is clamped into the end of fly cutter mounted to the spindle with a 4.25″ radius of swing and run at 160 RPM, with cutter face striking square to the steel bar with a 0.022″ in feed after initial touch off of blank to cutter contact, and run until failure or up to two hours.

In a specific example, Dynamic Impact Test was conducted on a MARS cutter (made by Diamond Innovations, Inc.) and a MERCURY cutter (also made by Diamond Innovations, Inc.). Both the MARS and MERCURY cutters are diamond compact cutters formed of a polycrystalline diamond layer on a cemented carbide substrate, in which the cutting surface is planar except for a 45 degree chamfer around the peripheral edge. The same Dynamic Impact Test was also conducted on modified MARS and MERCURY cutters. The modification is to add an angled portion to the cutting face of the traditional MARS and MERCURY cutters, wherein the angled portion has an angle relative to the longitudinal axis of the cutter of about 81 to about 89 degrees. MERCURY and MARS are trademarks of Diamond Innovations, Inc.

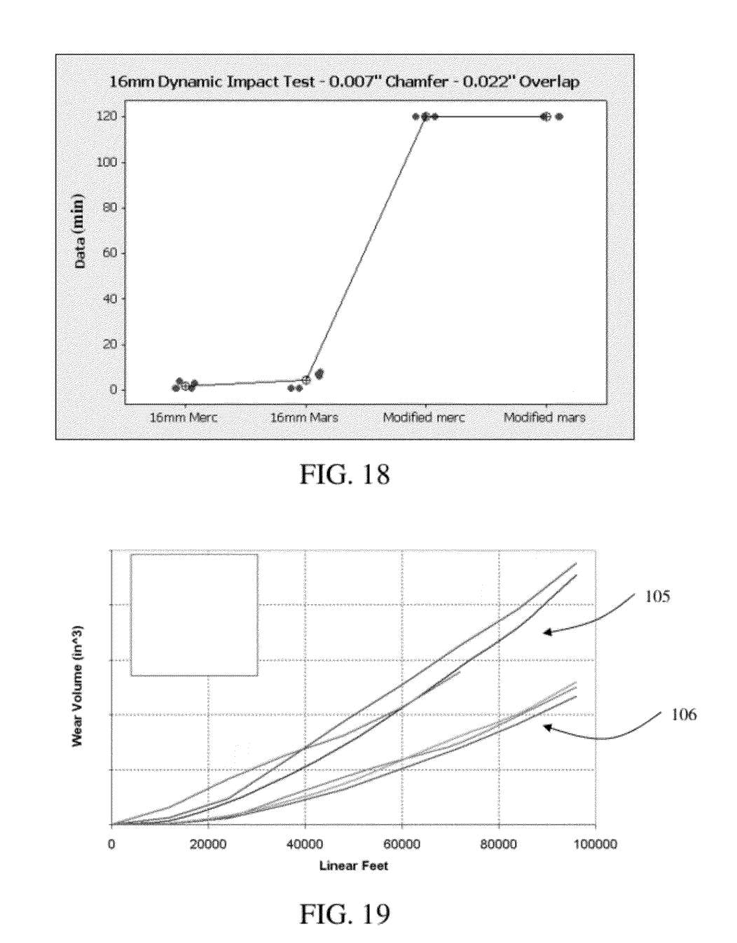

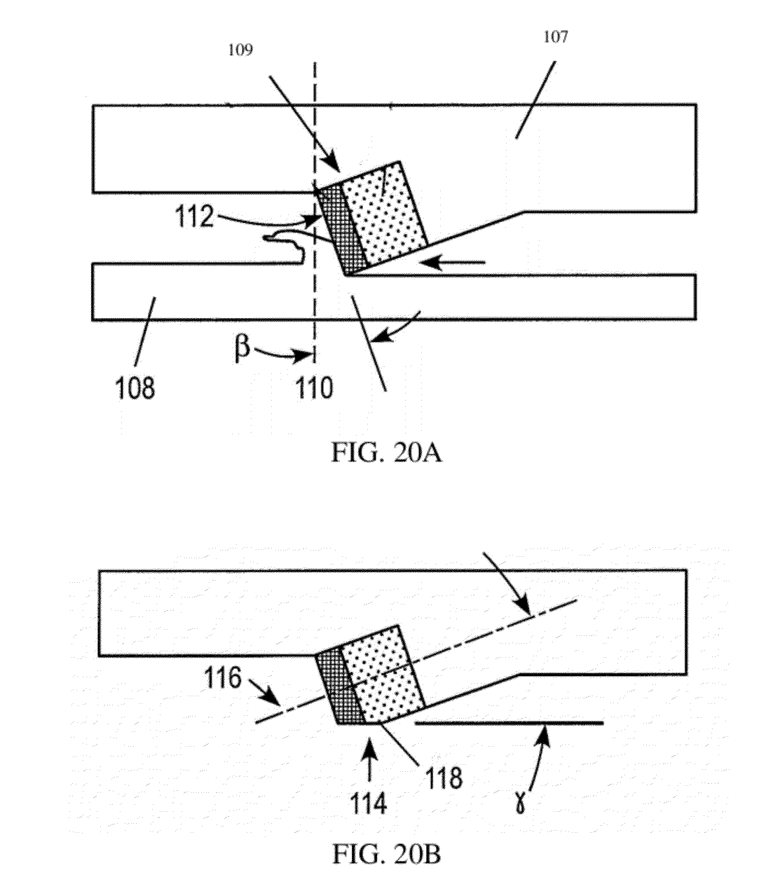

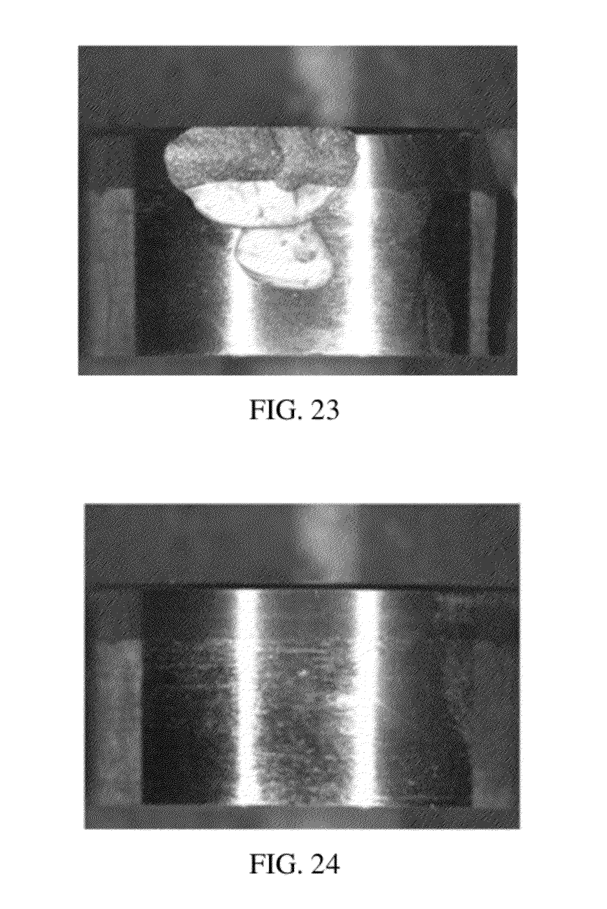

The results of the Dynamic Impact Test are illustrated in the line graph of FIG. 18, which shows that chipping occurs in the traditional MARS and MERCURY cutters after less than 10 minutes. In contrast, the modified MARS and MERCURY cutters do not show any chipping for at least 120 minutes. Further, FIG. 23 is a photograph of a traditional MARS cutter after 6 minutes of the Dynamic Impact Test. In contrast, FIG. 24 is a photograph of the modified MARS after 120 minutes of the Dynamic Impact Test.

A vertical turret lathe (VTL) test was performed by subjecting cutting elements to wear by face turning natural granite rock. To conduct the VTL test, a cutting element is oriented at a 15 to 20 degree back rake angle adjacent a flat surface of a Barre Gray Granite wheel having a diameter of 1.3 meters. Such formations may comprise a compressive strength of about 200 MPa. The cutting element travels on the surface of the granite rock at a linear velocity of 400 surface feet per minute while the cutting element was held constant at a 0.014 inch depth of cut to 0.200 inch depth of cut into the granite formation during the test. The feed is 0.140 inch depth of cut to 0.200 inch per revolution along the radial direction.

In a particular example, a traditional MERCURY 16 mm cutter and a modified MERCURY 16 mm cutter were subjected to the VTL test. The results of the VTL test are illustrated in the line graph of FIG. 19, which shows that the reduced chipping of the modified MERCURY 16 mm cutter results in less wear volume per linear feet of cutting. In particular, the three lines of the graph represented by reference number 105 correspond to traditional MERCURY 16 mm cutters. The three lines of the graph represented by reference number 106 correspond to modified MERCURY 16 mm cutters having an angled portion of the cutting face having an angle relative to the longitudinal axis of the cutter of 86 degrees.

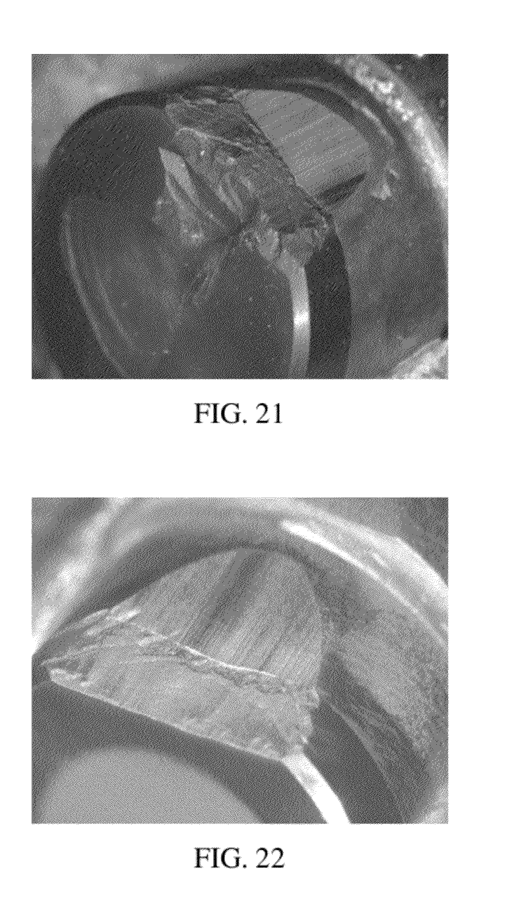

FIG. 21 is a photograph of a traditional MERCURY 13 mm cutter after being subjected to a VTL test. In contrast, FIG. 22 is a photograph of the modified MERCURY 13 mm cutter after being subjected to the same VTL test.

Although described in connection with preferred embodiments thereof, it will be appreciated by those skilled in the art that additions, deletions, modifications, and substitutions not specifically described may be made without department from the spirit and scope of the invention as defined in the appended claims.

What is claimed is:

1. A cutting element comprising a cutting face and a longitudinal axis passing through the cutting face, wherein at least a first portion of the cutting face is at an angle of about 81 to about 89 degrees relative to the longitudinal axis of the cutting element.

2. The cutting element of claim 1, wherein said cutting element comprises a diamond table, wherein said cutting face is located on a top surface of said diamond table.

3. The cutting element of claim 2, wherein the cutting element further comprises a substrate.

4. The cutting element of claim 2 further comprising a chamfer.

5. The cutting element of claim 4, wherein said chamfer ranges from about 20 degrees to about 70 degrees relative to the longitudinal axis of the cutting element.

6. The cutting element of claim 1, wherein said cutting face has a surface roughness of about 40 microinches or less.

7. The cutting element of claim 4, wherein said cutting face has a surface roughness of about 40 microinches or less.

8. The cutting element of claim 3 further comprising an interface between said diamond table and said substrate.

9. The cutting element of claim 8, wherein said interface is non-planar.

10. The cutting element of claim 1, wherein the cutting face further comprises at least a second portion and the cutting face having an angle relative to the longitudinal axis of the cutting element that is different from the angle of the first portion.

11. The cutting element of claim 10, wherein the cutting face further comprises three or more portions of the cutting face, each having a different angle relative to the longitudinal axis of the cutting element.

12. The cutting element of claim 1, wherein said cutting face is convex.

13. The cutting element of claim 1, wherein the first portion of the cutting face forms a ring around the longitudinal axis of the cutting element with the radial dimension of the ring being from about 0.5 mm to about 8 mm

14. The cutting element of claim 1, wherein the first portion of the cutting face surrounds the longitudinal axis of the cutting element, the extent of the first portion of the cutting face closest to the longitudinal axis has at least two radii, the first radius is greater or equal to the second radius.

15. The cutting element of claim 1, wherein the first portion of the cutting face surrounds and includes the point on the cutting face at the longitudinal axis of the cutting element.

16. The cutting element of clam 1, wherein the first portion of the cutting face includes the point on the cutting face at the longitudinal axis of the cutting element.

17. A cutting element comprising a cutting face, wherein at least a first portion of the cutting face is at an angle of about 81 to about 89 degrees relative to the longitudinal axis of the cutting element, and wherein the cutting face has a surface roughness of about 40 microinches or less.

18. A cutting element comprising:
a diamond table, a substrate, and a non-planar interface between said diamond table and said substrate,
wherein the diamond table comprises a cutting face,
wherein at least a first portion of the cutting face is at an angle of about 81 to about 89 degrees relative to the longitudinal axis of the cutting element,
wherein the cutting face has a surface roughness of about 5 to about 7 microinches, and
wherein the first portion of the cutting face forms a ring around the longitudinal axis of the cutting element with the radial dimension of the ring ranging from about 0.5 mm to about 8 mm.

19. The cutting element of claim 18, wherein said interface is a star interface.

20. The cutting element of claim 18, wherein said substrate comprises a cemented carbide substrate comprising chromium.

21. The cutting element of claim 18, wherein said diamond table is leached.

22. The cutting element of claim 18, wherein the radial dimension of the ring ranges from about 2 mm to about 4 mm.

23. A cutting element comprising a cutting face and a longitudinal axis passing through the cutting face, wherein at least a first portion of the cutting face is at an angle of about 81 to about 89 degrees relative to the longitudinal axis of the cutting element, and wherein the cutting element does not chip when subjected to a 16 mm dynamic impact test for at least 20 minutes.

24. The cutting element of claim 23, wherein the cutting element does not chip when subjected to the 16 mm dynamic impact test for at least 60 minutes.

25. The cutting element of claim 24, wherein the cutting element does not chip when subjected to the 16 mm dynamic impact test for at least 120 minutes.

26. The cutting element of claim 23, wherein the cutting element cuts for at least 60,000 linear feet with a wear volume of less than about 5e-4 in³ when subjected to a vertical turret lathe (VTL) test.

27. The cutting element of claim 26, wherein the cutting element cuts for at least 80,000 linear feet with a wear volume of less than about 1 e-3 in³ when subjected to the VTL test.

28. The cutting element of claim 26, wherein the cutting element exhibits chipping at an average distance of about 98,000 feet or more.

29. The cutting element of claim 26, further comprising a coating comprising CVD diamond.

30. The cutting element of claim 26, further comprising a coating comprising nano crystalline diamond.

31. A method of making a cutting element comprising forming a cutting element having a cutting face and modifying the cutting face to form at least a first portion of the cutting face having an angle of about 81 to about 89 degrees relative to the longitudinal axis of the cutting element, wherein the modifying step provides a surface roughness of about 40 microinches or less on the first portion of the cutting face.

32. The method of claim 31, wherein the modifying step is selected from the group of lapping, polishing, abrasive grinding, discharge machining methods, discharge grinding methods, tribochemical machining, laser cutting,

33. A cutting element for drilling subterranean formations comprising a cutting face, a cutting edge at the periphery of the cutting face, and a longitudinal axis passing through the cutting face, the cutting face comprises at least a first portion at an angle of about 81 to about 89 degrees relative to the longitudinal axis of the cutting element, wherein the cutting element plows and shears the subterranean formation such that at least a portion of the first portion of the cutting face is engaged with the subterranean formation.

34. The cutting element of claim 33, wherein the depth that the cutting element cuts into the subterranean formation is at least about 250 microns.

35. A method of using the cutting element of claim 33, comprising cutting the cutting element to a distance of at least 100 meters into the subterranean formation and plowing and shearing the subterranean formation such that at least a portion of the first portion of the cutting element engages the subterranean formation.
